(19) United States
(12) Patent Application Publication
(10) Pub. No.: US 2001/0029858 A1
(43) Pub. Date: Oct. 18, 2001

(54) Printing machine

(76) Inventors: Klaus Gerhard, Ladbergen (DE); Volker Schroeder, Ladbergen (DE)

Correspondence Address: JACOBSON, PRICE, HOLMAN & STERN, PROFESSIONAL LIMITED LIABILITY COMPANY, 400 SEVENTH STREET, N.W., WASHINGTON, DC, 20004, US

(21) Appl. No.: 09/820,623

(22) Filed: Mar. 30, 2001

(30) Foreign Application Priority Data
Apr. 17, 2000 (DE) 100 18 995.4

(51) Int. Cl. B41F 31/02

(52) U.S. Cl. 101/367

(57) ABSTRACT

A printing cylinder of a printing machine that can be immersed in an ink pan is provided with a doctor blade that can be adjusted to it. In order to prevent ink from spraying outward, rings are placed that can rotate freely, but cannot be moved in the axial direction, and carry holding arms that hold wipers in the region between the ink pan and the doctor blade. The rings are held by torque supports in such a way that they cannot rotate with respect to the machine frame.

The invention concerns a printing machine, preferably an intaglio web-fed rotary press, with a printing cylinder that can be immersed in an ink pan and a doctor blade that can be installed in it.

In intaglio web-fed rotary presses of this kind, the problem exists that ink also sprays out below the knife of the doctor blade installed on the printing roller, whereby the printing machine become dirty and disturbances can be caused due to crust formation.

The task of the invention is therefore to provide a printing machine of the kind described in the introduction, by which spraying of ink outward to one side is prevented.

According to the invention, this task is solved by placing rings on the shaft pins of the printing cylinder that can turn freely, but are immovable in the axial direction, carried by holding arms that hold a wiper in the region between the ink pan and the doctor blade in position in the edge region of the printing cylinder, and that the rings are held without rotation with respect to the machine setting by torque supports.

The wipers provided according to the invention in the edge regions of the printing cylinder wipe the ink from the edge regions, from where they otherwise spray out, and lead them back to the ink pan.

Appropriately, wipers are also arranged in the region of the ink pan, so that the ink wiped from the edge regions can be led back to the ink pan on a short path.

The wipers according to the invention are connected to the printing cylinder directly by these bearing rings, so that even when the printing cylinder moves axially, for example a forward and backward movement, they are still held in unchanged position in the edge region of the printing cylinder, without a need existing for later leading. The torque supports assure that the wiper always wipes the ink from the edge regions to the ink pan in the same regions.

Appropriately, the wipers are formed obliquely, in such a way that they lie with one handle on the mantle and with the other handle at a front side of the printing roller.

In another embodiment of the invention, it is provided that adjustable wipers are provided at the doctor-blade holder below the doctor-blade knife in the end region of the printing cylinder. These wipers assure that no ink can spray away, even in the region of the doctor blade, to the side of the printing cylinder.

The wipers appropriately extend outward beyond the edges of the printing cylinder. In this way, it is assured that even if the printing cylinder moves axially, the wipers do not leave the edge region.

The wipers consist appropriately an elastomer material.

In another embodiment of the invention, it is provided that the region between the upper and lower wipers is covered by a spray hood, which opens into the ink pan. Ink sprayed radially by the printing cylinder is captured by this spray hood and led directly back into the ink pan.

A device with the characteristics of the printing machine can also be used for application of sizing or another coating material onto a material web.

An embodiment example of the invention will be explained in the following, with reference to the drawings. Here:

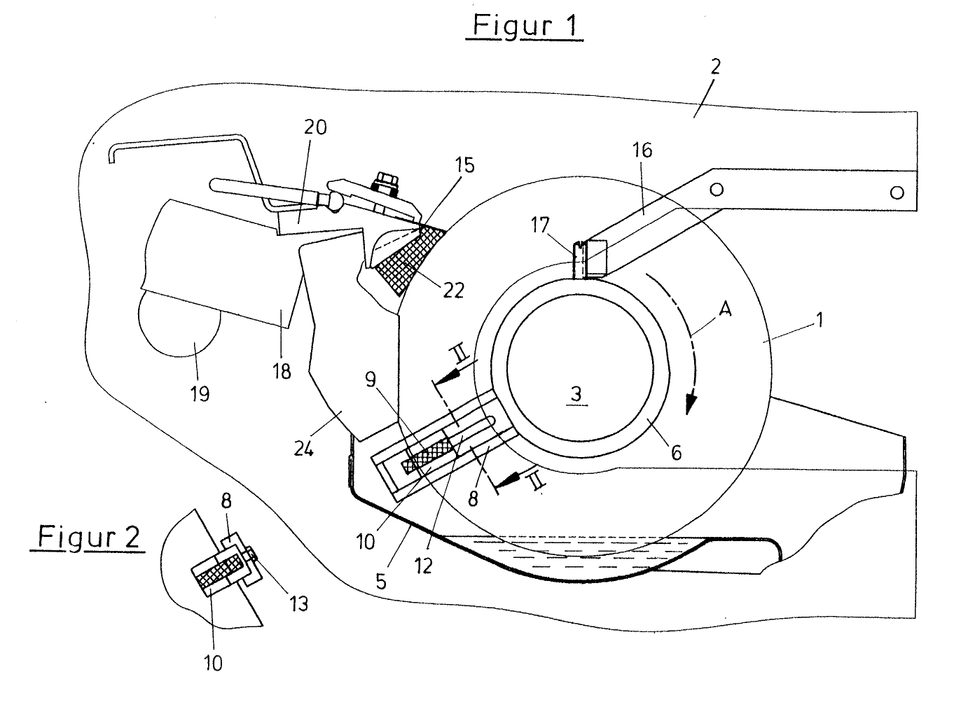

FIG. 1 shows a side view of a printing roller of an intaglio web-fed rotary press in a schematic representation,

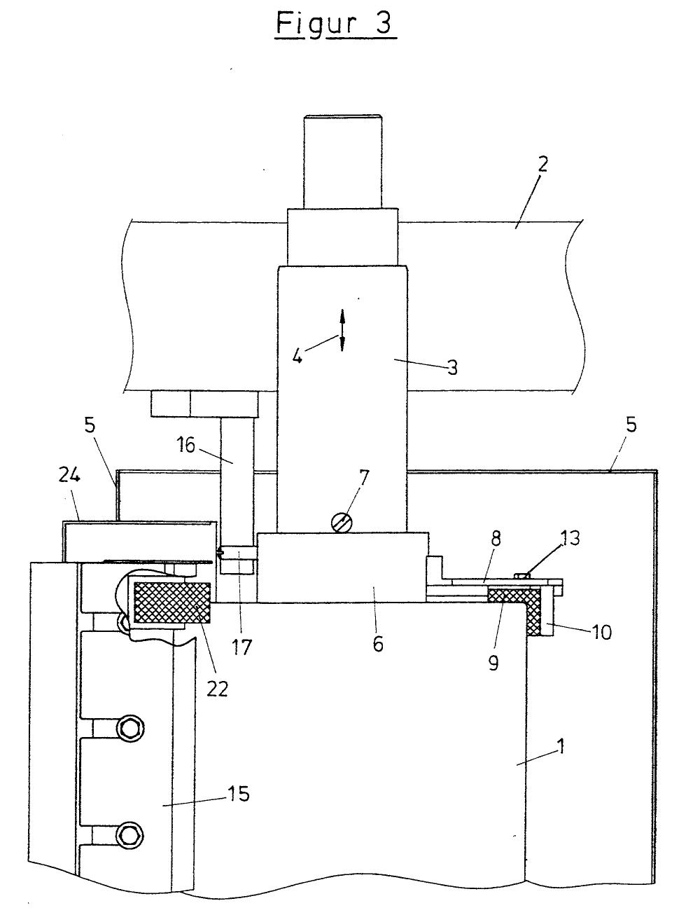

FIG. 2 shows a section through the holding arm of a wiper along line II-II in FIG. 1, and

FIG. 3 shows a top view of an end region of the printing roller according to FIG. 1.

The invention will be explained in the following with the example of an intaglio web-fed rotary press, of which only the printing roller with doctor blade and ink pan is shown.

In the side parts of the printing-machine set, of which on one side part 2 is shown, the printing cylinder 1 is mounted on bearings in the usual way by its shaft pins 3. The printing cylinder 1 can be mounted on bearings in the side parts 2 so as to be movable back and forth in the direction of the double arrow 4, whereby a reversible drive can be provided for this movement.

Below the printing roller 1 in the machine frame, an ink pan 5 is held, which is filled up to predetermined height with ink 6, and into which the printing roller is immersed. The ink pan 5 receives the lower part of the printing roller 1, so that it captures ink that runs or is sprayed from the printing roller 1.

At each shaft pin 3, a ring 6 is placed so as to rotate freely, which is held the ring-shaped front of the printing roller 1 and a pin 7 screwed radially into the shaft pins 3 between the shaft pins 3 and the mantle of the printing roller 1 so that it cannot be moved in the axial direction. At the ring 6, a radial arm 8 is attached, which carries a wiper 9 of a suitable material, for example a plastic or an elastomer material. This wiper is formed obliquely and lies with one handle at the end region of the mantle of the printing roller 1 and with the other handle at the ring-shaped front surface of the printing roller. The wiper 9 is attached in a groove of an angle piece 10, on handle of which is placed in a groove of the holding arm 8 in such a way that it can move radially to the printing roller 1. The holding arm 8 is provided with long hole 12 in its bridge part, through which a holding screw 13 goes, which is screwed into the handle of the angle piece 10 placed so as to move in the groove of the holding arm, so that the oblique wiper 9 can be moved in the radial direction to adjust to various printing-roller diameters and fixed in a set position. In order for the oblique wiper 9 to be able to be set also in the axial direction, the holding arm can also be attached to the ring 6 in such a way that it can be set in the axial direction.

The wiper 9 is arranged in the manner shown in FIG. 1 in the direction A of rotation of the printing roller 1 above the level of the ink 6 between the ink pan 5 and the doctor-blade knife 15, in order to lead ink wiped from the edges of the printing roller 1 on a short path.

In order to assure that the wiper 9 maintains its position relative to the machine frame, the side parts 2 are provided with torque supports consisting of projecting arms 16, on which the rings are supported on radial pins screwed in above it.

At a doctor-blade beam 18 extending between the side parts 2, which can be moved and set by end pins 19 in the side parts 2, the doctor-blade knife is mounted on bearings by means of a usual doctor-blade holder 15, which can be adjusted to the printing roller 1 in the manner shown. The type of attachment of the doctor blade 15 with adhesive pieces and eccentric tension elements is known and will therefore not be described in more detail. Below the doctor blade 15, on both sides in the end region of the printing roller 1 at the doctor-blade holder 20, a wiper 22 of a suitable material, for example a plastic or an elastomer, is attached. These wipers 22 protrude, in the manner shown in FIG. 3, beyond the edges of the printing roller 1, so that they do not leave the edge region even when the printing roller 1 is moved axially. The wipers 22 prevent ink from spraying to the side in the region below the doctor-blade knife 15.

A spray hood 24 is attached to the doctor-blade beam 18, which captures ink spraying from the printing roller and leads it back to the ink pan 5. The spray hood 24 is open at its lower end, so that the ink captured in this way can flow back into the ink pan 5.

1. A printing machine, advantageously an intaglio web-fed rotary press, with a printing cylinder (1) that can be immersed in an ink pan (5) and an doctor blade (15) that can be adjusted to it,
characterized by the fact that the shaft pins (3) of the printing cylinder (1) can rotate freely, but is placed on rings (6) that cannot move in the axial direction and that carry the holding arms (8), which hold wipers (9) in position in the region between the ink pan (5) and the doctor blade (15) in the edge regions of the printing cylinder (1) and that the rings (6) are held by torque supports (16) in such a way that they cannot rotate with respect to machine frame (2).

2. A printing machine according to claim 1, characterized by the fact that the wipers (9) are formed obliquely, in such a way that they lie with one handle at the mantle and with the other handle at the front of the printing roller (1).

3. A printing machine according to claim 1 or 2, characterized by the fact that adjustable wipers (22) are arranged the doctor-blade holder (2), below the doctor-blade knife (15) at the end region of the printing cylinder (1).

4. A printing machine according to claim 3, characterized by the fact that the wipers (22) project outward beyond the edges of the printing cylinder (1).

5. A printing machine according to one of claims 1 through 4, characterized by the fact that the wipers (9, 22) consist of an elastomer material.

6. A printing machine according to one of claims 1 through 5, characterized by the fact that the region between the upper and lower wipers (9, 22) is covered by a spray hood (24), which opens into the ink pan (5).

7. Use of a printing machine with the characteristics of claims 1 through 6 for applying sizing or another coating material to a material web.
